(19) United States
(12) Patent Application Publication
(10) Pub. No.: US 2005/0076091 A1
(43) Pub. Date: Apr. 7, 2005

(54) Data mirroring

(76) Inventors: Duncan Missimer, Sunnyvale, CA (US); Aaditya Rai, Palo Alto, CA (US); Ketan Shah, Mountain View, CA (US); Subhojit Roy, Maharashtra (IN)

Correspondence Address: Berkeley Law and Technology Group, 680 NW Altishin Place, Beaverton, OR, 97006, US

(21) Appl. No.: 10/661,345

(22) Filed: Sep. 11, 2003

(51) Int. Cl. G06F 15/16; G06F 15/173

(52) U.S. Cl. 709/217; 709/219

(57) ABSTRACT

Embodiments of methods, devices, and/or systems for data mirroring are described.

### RELATED APPLICATION

Pursuant to 35 USC 119(e), this original patent application claims priority from a provisional patent application filed on Sep. 2, 2003, titled “Data Mirroring,” by Missimer et al., (attorney docket number 003.P001), U.S. provisional application number ______, assigned to the assignee of the currently claimed subject matter.

### BACKGROUND

This disclosure is related to data mirroring.

It is desirable, particularly in networking, such as in a storage area network (SAN), for example, to have the ability to write data to more than one place at substantially the same time. However, typically, in such an environment, different devices and/or systems have different read and/or write capabilities at the time it is desired that such a request be executed.

### BRIEF DESCRIPTION OF THE DRAWINGS

Subject matter is particularly pointed out and distinctly claimed in the concluding portion of the specification. The claimed subject matter, however, both as to organization and method of operation, together with objects, features, and advantages thereof, may best be understood by reference of the following detailed description when read with the accompanying drawings in which:

FIG. 1 is a flowchart illustrating an embodiment of mirroring data applied to a specific data storage example.

FIG. 2 is a flowchart further illustrating the embodiment of FIG. 1 applied to a specific example.

FIG. 3 is a flowchart illustrating another embodiment of mirroring data applied to a specific data storage example.

FIG. 4 is a flowchart further illustrating the embodiment of FIG. 3 applied to a specific example.

FIG. 5 is a flowchart further illustrating the embodiment of FIG. 3 applied to a specific example.

FIG. 6 is a flowchart further illustrating the embodiment of FIG. 3 applied to a specific example.

FIG. 7 is a block diagram of an embodiment of a mirroring device.

FIG. 8 is a block diagram illustrating an embodiment of a network including a mirroring device.

FIG. 9 is a block diagram illustrating another embodiment of a network including a mirroring device.

### DETAILED DESCRIPTION

In the following detailed description, numerous specific details are set forth to provide a thorough understanding of the claimed subject matter. However, it will be understood by those skilled in the art that the claimed subject matter may be practiced without these specific details. In other instances, well-known methods, procedures, components and/or circuits have not been described in detail so as not to obscure the claimed subject matter.

In a fabric-based virtualization environment, such as described, for example, in Patent Application “METHOD AND APPARATUS FOR VIRTUALIZING STORAGE DEVICES INSIDE A STORAGE AREA NETWORK FABRIC,” by Naveen Maveli, Richard Walter, Cirillo Lino Costantino, Subhojit Roy, Carlos Alonso, Mike Pong, Shahe H. Krekirian, Subbarao Arumilli, Vincent Isip, Daniel Chung, Steve Elstad, filed on Jul. 31, 2002, U.S. patent application Ser. No. 10/209,743, assigned to the assignee of the presently claimed subject matter (attorney docket number 112-0053US), for a virtual disk being mirrored that is exported to one or more hosts in the fabric, write input/ouput (IO) commands from the one or more hosts, hereinafter referred to as an initiator, are replicated onto multiple targets, typically, but not necessarily, physical storage disks. As previously indicated, it is desirable, particular in networking, such as in a storage area network (SAN), for example, to have the ability to write data to more than one place at substantially the same time. However, typically, in such an environment, different devices and/or systems have different read and/or write capabilities at the time it is desired that such a request be executed.

It is desirable to write data to more than one place or location at least in part to build redundancy. However, this may prove challenging in networks, such as those with a variety of devices that may not all be able to accommodate the same data request at the same time, or for other reasons. The following discussion employs the fibre channel protocol (FCP) for implementing data transfer and signaling; however, the claimed subject matter is not limited to FCP. FCP is merely provided for purposes of illustrating a potential implementation using a prevalent protocol. Many other networking protocols may alternatively be employed, including TCP/IP and Ethernet, for example. Likewise, the foregoing patent application, U.S. patent application Ser. No. 10/209,743 (attorney docket number 112-0053US) is merely provided as one example of a virtualization environment. The claimed subject matter is not limited in scope to this particular example patent application or to only virtualization environments.

Mirroring involves duplicating, synchronously, data to two or more volumes, referred to here as logical unit numbers (LUNs), or targets, while the original write may be directed to one LUN or target, for example. In this context, a target refers to a virtual or non-virtual device that data may be read from and/or written to either virtually or non-virtually in a networked environment, such as a storage area network (SAN), for example. In the write, a SCSI CMD block may be received, for example, indicating a write, a LUN and a length. In one embodiment, this may be captured and duplicated to the other LUNs or targets. Typically, a target or LUN will return a SCSI XFER_RDY block (hereinafter referred to as XFER_RDY or XF), indicating ready status. However, a problem may occur here in that at least one of the targets may not accept a block of the requested length.

The following describes one embodiment of an approach to address the issue of mirroring writes in the presence of targets that may start at the same data offset, but may accept different data lengths, although, of course, the claimed subject matter is not limited in scope to this particular embodiment.

The issue may arise in mirroring devices, such as a fibre channel switch, as described in, for example, Patent Application “Fibre Channel Zoning by Device Name in Hardware,” by Ding-Long Wu, David C. Banks, and Jieming Zhu, filed on Jul. 17, 2002, U.S. patent application Ser. No. 10/123,996, (attorney docket number 112-0015US); and in Patent Application “STORAGE AREA NETWORK PROCESSING DEVICE,” by Venkat Rangan, Anil Goyal, Curt Beckmann, Ed McClanahan, Guru Pangal, Michael Schmitz, Vinodh Ravindran, filed on Jun. 30, 2003, U.S. patent application Ser. No. 10/610,304, (attorney docket number 112-0112US), both of the foregoing patent applications assigned to the assignee of the presently claimed subject matter, which may convert single write requests into multiple write requests for reasons such as achieving redundancy of data, as suggested above. It is, of course, appreciated that the claimed subject matter is not limited to the switch implementations described in the foregoing patent applications. These applications are provided merely as examples. Nonetheless, in such an environment, the pace of write data transmission may be controlled at least in part by storage devices that will be receiving the data. However, if, for example:
several are handling a request; and/or
this is not agreement on the amount of data to accept; and/or
the mirroring device cannot store or buffer the data to allow a slower or smaller device to catch up;
   it may be desirable for an intermediate device to have a way of satisfying the storage devices while also satisfying the initiator which is requesting the write operation.

In an alternative embodiment, described in more detail below, the mirroring device may repeatedly abandon and shorten the write command to the storage devices until they agree on the amount of data to accept. In both the immediately following embodiment and the alternative embodiment described below, the request may be aborted and then one copy may be written if the storage target devices do not agree on a starting offset, although the scope of the claimed subject matter is not limited in scope in this respect. In the immediately following embodiment, however, if the offsets are the same, but the lengths do not match, the request is not aborted. This particular technique is analogous to sliding windows employed in network stacks, such as TCP, but here applied to multiple recipients.

In this particular embodiment, the system may employ two variables, here, the highest endpoint acceptable to the multiple devices or targets, for this particular embodiment, the minimum of XFER_RDYs received, and the highest XFER_RDY sent back to the I/O requester. When the first variable exceeds the second, it is due at least in part to a new XFER_RDY frame arriving that will allow the requester to send more data, referred to in this context as “opening the window.” If an XFER_RDY arrives, but it does not raise the acceptable data transfer to the storage targets, the new value for this target is noted but nothing is sent to the initiator. Thus, the XR command is not acted upon. The target or device that is holding up the request will issue a new XFER_RDY when it gets the data it requested earlier and will issue a new, higher XFER_RDY, raising the acceptable level and allowing more data to flow to the targets.

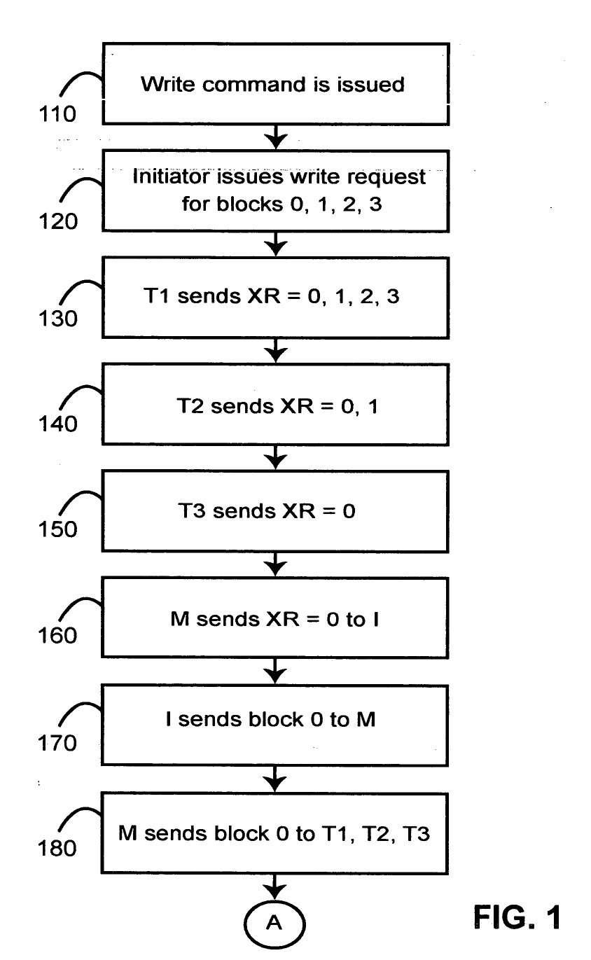

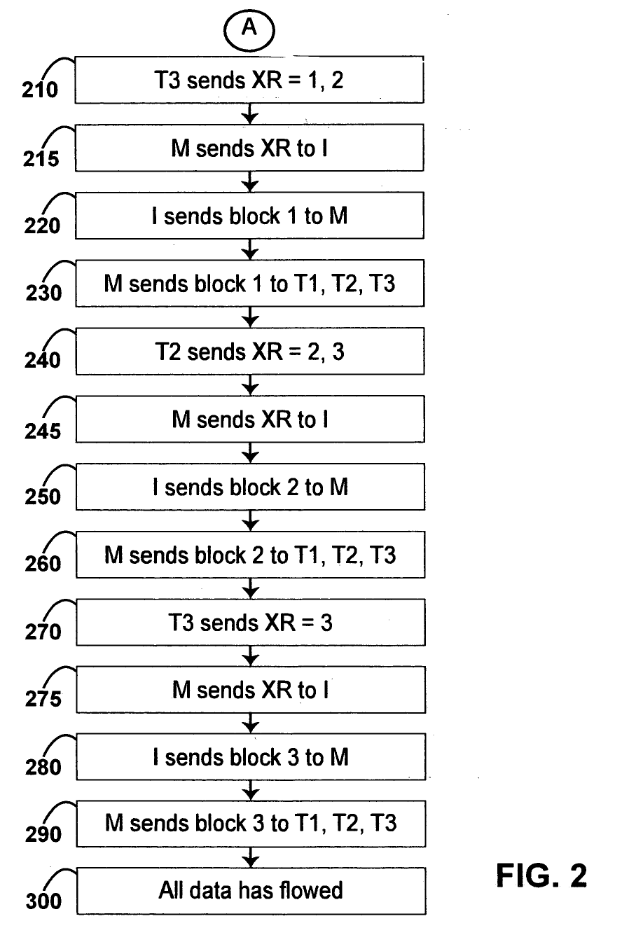

FIGS. 1 and 2 illustrate the foregoing embodiment applied to a specific data storage example. In this example, the entity issuing a write command is referred to as initiator, I, the mirroring device is referred to as M, e.g. a FC switch as described above, for example, the storage devices or “targets” are referred to as T1, T2, T3, and XR refers to the XFER_RDY frame or signal, which here refers to a target request for a range of blocks. It is noted that the XFER_RDY frame or XR is employed in FCP; however, as previously described, the claimed subject matter is not limited in scope to FCP. FCP is merely employed to provide one example implementation; however, many other implementations other than FCP are also possible and are within the scope of the claimed subject matter.

As illustrated by 110 and 120 in FIG. 1, the initiator issues a write request for blocks 0,1,2,3. At 130, T1 sends XR=0,1,2,3. Through this signaling, T1 has indicated an ability to receive all the data at once; however, at this point, the acceptable amount of data to receive of the three targets is nothing, so no XR command is sent to the initiator at this time in this particular example.

At 140, T2 sends XR=0, 1 to M. Through this signaling, target T2 indicates the ability to receive the first two blocks of data, but T3 is still not ready, so the window is still not open.

At 150, T3 sends XR=0 to M. Thus, through signaling, T3 indicates the ability to take the first block of data. The computed acceptable to all targets now exceeds the amount of data already sent and M concludes that the window has opened. An XR for block 0 is forwarded to I at 160. At 170, I sends block 0 to M, which sends it to T1, T2, and T3 at 180. The data has satisfied the request of the three targets, so the window is closed, in this particular embodiment. Thus, FIG. 1 illustrates a process whereby, for this particular embodiment, the window for data transfer is opened and then closed.

In the example so far, block 0 satisfied the XR signal of T3. T3, thus, now sends a new XR, as illustrated by 210 in FIG. 2. Here, the XR is 1,2. The window is now open again, because the acceptable data transfer to the targets (block 1) is greater than what has been sent (block 0). However, T2 is the target that is now limiting data transfer, so M sends an XR for block 1 to I. I sends block 1 to M, illustrated by 220, and M sends it to T1, T2, T3, illustrated by 230.

T2 is now satisfied, and sends back XR for 2, 3, illustrated by 240. The window opens again, but the acceptable level is now set by T3, so M sends XR=2 to I, which responds with block 2, as illustrated by 250. Block 2 goes to all targets, illustrated by 260, and satisfies T3, which issues XR=3, at 270. This allows the last block to flow, illustrated by 280, 290 and 300.

For this particular embodiment, T1, which issued an earlier request for the entire amount, receives all four expected blocks without being aware of any unusual behavior on the part of M, I or the other targets. Thus, the process is transparent to the targets, which may at worst register unusual delays between blocks, while the other parties are negotiating new transfers.

As the above discussion illustrates, this particular embodiment includes components of an initiator, typically provided by a host or host devices of the fabric, a non-buffering mirroring device, sometimes referred to as a virtualizer in a virtualization environment, and two or more storage targets, which may be virtual or non-virtual. An advantage is that no buffering storage is necessarily employed at M and the replication that happens is transparent to the initiator and the targets. Moving mirroring functionality from many initiators to a single entity, M, for example, in the previously described embodiment, reduces the number of points of administration and the amount software management, thus, potentially reducing cost. However, in contrast to this particular embodiment, typical initiator-based mirroring schemes may employ buffering. Examples of such schemes include HP-UX, Linux LVM and/or Veritas VxVM, for example. Of course, while little or no buffering is one potential advantage of this particular embodiment, embodiments that employ buffering are not excluded from the scope of the claimed subject matter. Thus, embodiments that employ buffering are specifically included within the claimed subject matter.

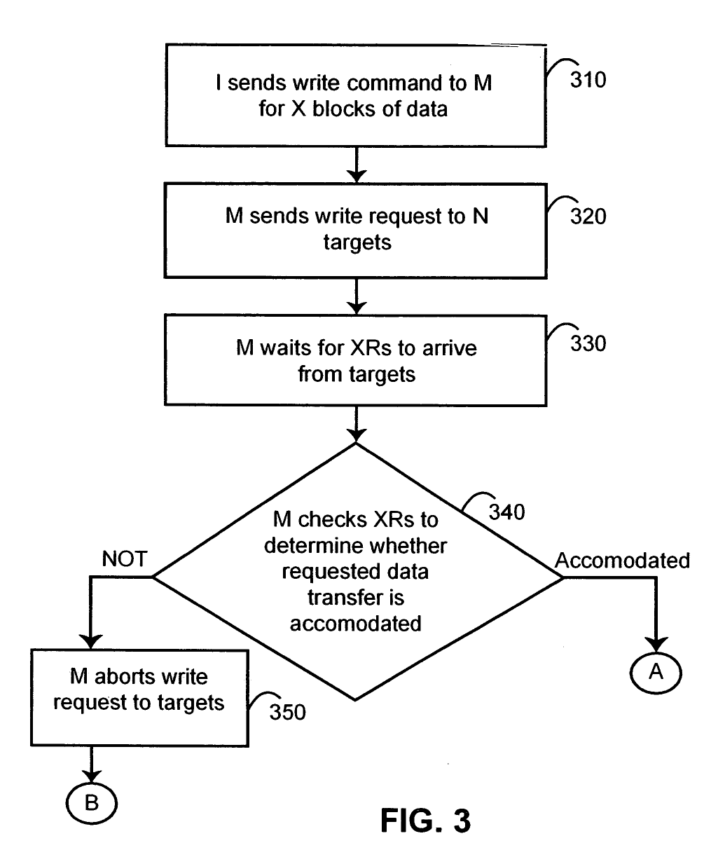

Yet another embodiment of a method for mirroring data is provided hereinafter, as illustrated in FIGS. 3 to 6, although, again, the claimed subject matter is not limited in scope to this alternative embodiment. At 310 of FIG. 3, for example, M receives a WRITE SCSI command from I. Here, I may comprise one or more hosts in a virtual fabric. Likewise, here, data to be replicated may comprise a virtual disk (VD) to be mirrored. The size of the WRITE may comprise, for example, “X” disk blocks, although the claimed subject matter is not limited in scope in this respect. It is noted that another name for M may be “virtualizer” (V). After a lookup of the virtual disk maps, M or V “realizes” that it is a mirrored VD and, thus, at 320 sends multiple WRITE commands to N destinations or targets, which, as previously described, may comprise physical storage disks. In this particular embodiment, M creates SCSI WRITE command blocks (CDBs) for N targets of size “X” blocks and sends it to the targets (after proper modification of the FC header with appropriate S_ID, D_ID, OX_ID, RX_ID etc.), although, again, while this example refers to the FCP, the claimed subject matter is not limited in scope in this respect. M then waits for XFER_RDY frames to arrive from the targets, as shown, for example, at 330 of FIG. 3.

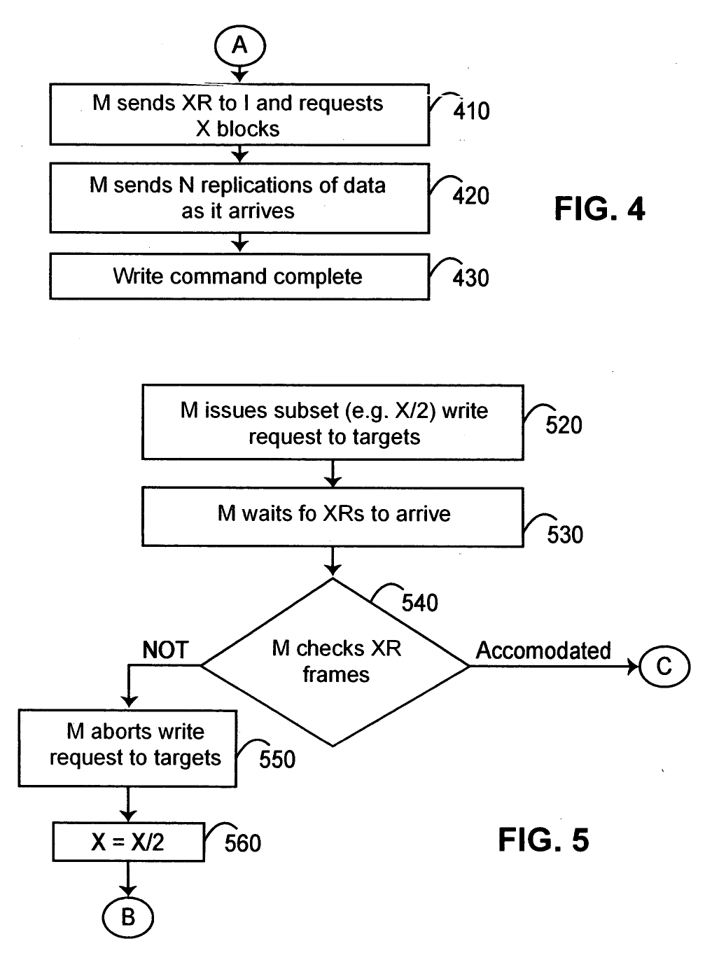

On receiving the XFER_RDY frames, at 340, M checks whether the data transfer length that is requested covers the entire data transfer request, in this example, X blocks. If the data lengths all match and cover the entire 10 size, M sends one XFER_RDY frame to I and requests X blocks of write data, as shown by 410 of FIG. 4. As the FCP_DATA frames, for this particular embodiment employing FCP, arrive at M, the frames are replicated, in this example; N times, and sent to the targets, illustrated by 420 of FIG. 4. For this embodiment, this may occur directly via hardware, based on the IO-Table entries, although the claimed subject matter is not limited in scope in this respect. Once the data transfer is complete, the targets in this embodiment may send a GOOD SCSI status to M and M may send such a status frame to I to indicate completion of the mirrored write command, shown as 430 in FIG. 4.

Alternatively, if at 340 of FIG. 3, M determines that the XFER_RDY sizes from the targets do not match or do not cover the entire requested size of the data to be transferred, it aborts the write request to the targets, as shown by 350 of FIG. 3. In this embodiment, M sends ABTS frames to abort the WRITE requests, although, again, the claimed subject matter is not limited in scope to FCP.

In this embodiment, M re-issues N WRITE commands to the targets, here with an X/2 transfer size instead, as shown by 520 in FIG. 5, and waits for the targets to respond with XRs, as shown by 530. It is, of course, appreciated that the claimed subject matter is not limited in scope to reducing the transfer size to X/2. For example, alternatively, any subset, such as X/n, may be employed, where n is any number, not simply an integer. Likewise, n may be tunable. Furthermore, another embodiment may include a subset X-Y, where Y is tunable.

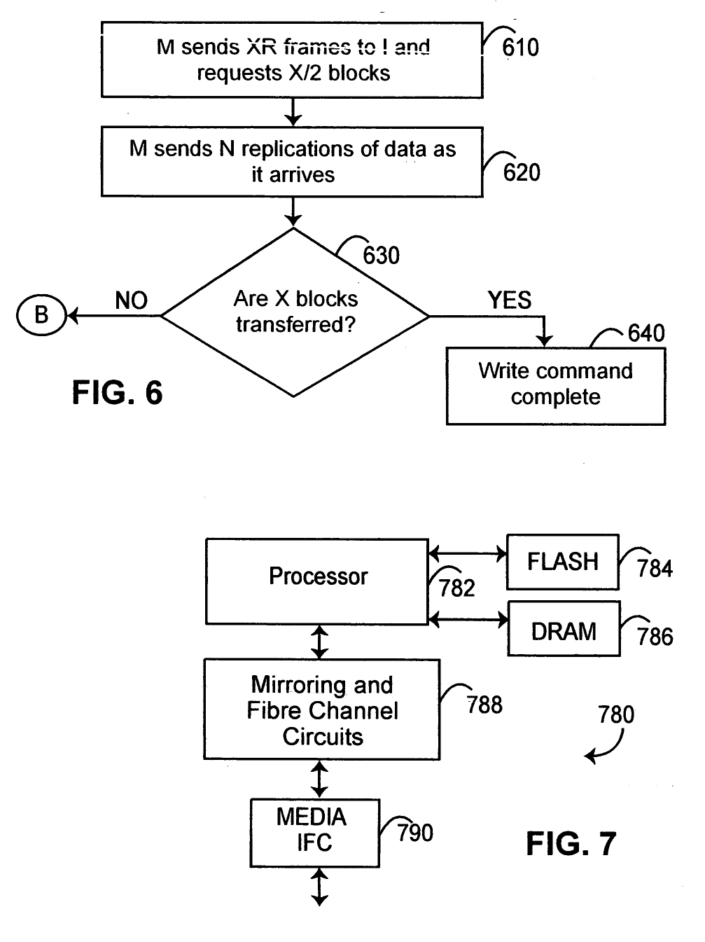

However, continuing with this example embodiment, if the targets respond with XFER_RDYs that cover the entire IO length, here X/2 blocks, illustrated by 540 in FIG. 5, M then sends a single XFER_RDY frame of size X/2 blocks to I, illustrated by 610 of FIG. 6. Again, for this particular embodiment, the FCP_DATA frames are then received from I by M, replicated, and sent to the appropriate targets. However, if, instead, it is found that there is a XFER_RDY from a target that does not match the full command length, the write requests are cancelled or aborted, depicted by 550, and WRITE IOs of X/4, that is, X/2/2, are then tried, as shown by 560 and 520 of FIG. 5. Although, again, in an alternative embodiment, any further subset may be employed. In this embodiment, this process repeats until XFER_RDYs match. This is depicted in FIG. 5 by the loop from 560 to 520.

Assuming, for example, that the WRITE command translated to WRITE IOs to targets of size X/2 is successful, when M receives responses for that command from the targets, new WRITE commands of size X/2 having an offset (LBA) set to “original LBA+X/2” are issued to the targets and the process previously described is repeated until XFER_RDYs match. This is depicted in FIG. 6 by 630 and the loop back to 520 of FIG. 5. When the entire transfer length is completed and responses from the targets are received, such as with GOOD SCSI status frames, for this particular embodiment, a GOOD SCSI status frame, for this particular embodiment, may be sent to I. That completes the mirrored write command for this particular embodiment.

As previously discussed, one advantage of the foregoing embodiments is that it is not necessary that buffering be employed. Likewise, another advantage is that the mirroring may occur at “wire speed” since data is not transferred until devices are ready to receive it. However, it is appreciated that the claimed subject matter is not limited to the foregoing embodiments. Embodiments may be within the scope of the claimed subject matter and not possess the aforementioned advantages.

FIG. 7 is a block diagram of a mirroring device 780. A processor 782, with associated flash memory 784 and RAM 786, is coupled to mirroring and Fibre Channel circuits 788, which in turn are coupled to Fibre Channel media interface(s) 790. Processor 782 and circuits 788 may cooperate to perform the operations described above.

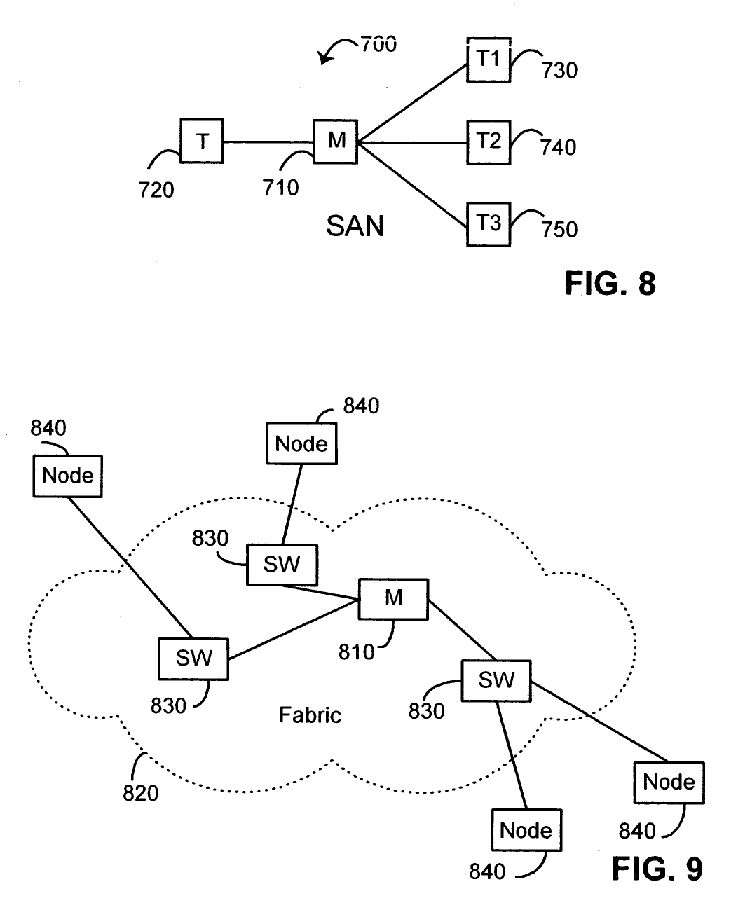

FIG. 8 is a schematic diagram illustrating an embodiment of a network including a mirroring device, although, of course, the claimed subject matter is not limited in scope to this particular embodiment. Embodiment 700 includes mirroring device 710, initiator 710 and targets 730, 740 and 750. In this embodiment, these devices are included in a storage area network (SAN). Likewise, FIG. 9 illustrates an embodiment of a network including a mirroring device 810 included in a fabric 820. Fabric 820 in embodiment 800 is formed by switches, such as 830, and mirroring device 810. Switches 830 are coupled to nodes 840. Example nodes are hosts and target devices, such as RAID units, JBOD units and tape libraries. Again, these examples are merely provided for purposes of illustration and the claimed subject matter is not limited in scope to these example embodiments.

It will, of course, be understood that, although particular embodiments have just been described, the claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example. Likewise, although the claimed subject matter is not limited in scope in this respect, one embodiment may comprise one or more articles, such as a storage medium or storage media. This storage media, such as, one or more CD-ROMs and/or disks, for example, may have stored thereon instructions, that when executed by a system, such as a computer system, computing platform, or other system, for example, may result in an embodiment of a method in accordance with the claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive, although, again, the claimed subject matter is not limited in scope to this example.

In the preceding description, various aspects of the claimed subject matter have been described. For purposes of explanation, specific numbers, systems and configurations were set forth to provide a thorough understanding of the claimed subject matter. However, it should be apparent to one skilled in the art having the benefit of this disclosure that the claimed subject matter may be practiced without the specific details. In other instances, well-known features were omitted or simplified so as not to obscure the claimed subject matter. While certain features have been illustrated and described herein, many modifications, substitutions, changes and equivalents will now occur to those skilled in the art. It is, therefore, to be understood that the appended claims are intended to cover all such modifications and changes as fall within the true spirit of the claimed subject matter.

1. A method of mirroring data to multiple targets where the targets request different data lengths, comprising:
transferring data to multiple targets, if an acceptable data transfer of said multiple targets is greater than 0.

2. The method of claim 1, wherein transferring data to multiple targets comprises: transferring data to all targets.

3. The method of claim 1, and further comprising:
not acting upon a request to transfer data if the request does not raise the acceptable data transfer by said multiple targets.

4. The method of claim 3, wherein not acting upon a request to transfer data comprises:
not acting upon a request if the request does not raise the acceptable data transfer by all targets.

5. The method of claim 3, and further comprising:
transferring data to multiple targets if a request for data transfer raises the acceptable data transfer by said multiple targets.

6. The method of claim 5, transferring data to multiple targets comprises:
transferring data to all targets.

7. The method of claim 1, and further comprising:
transferring data to multiple targets if a request for data transfer raises the acceptable data transfer by said multiple targets.

8. The method of claim 7, transferring data to multiple targets comprises:
transferring data to all targets.

9. The method of claim 1, wherein at least one of said multiple targets comprises a storage disk.

10. The method of claim 1, wherein said targets comprise systems that are compliant with the fibre channel protocol.

11. The method of claim 1, wherein said targets comprise systems that are compatible with the fibre channel protocol.

12. A method of mirroring multiple blocks of data to multiple targets, if said multiple targets do not satisfy an amount of data to be transferred of said multiple blocks of data, comprising:
transmitting a write request for half of said multiple blocks of data to said multiple targets.

13. The method of claim 12, wherein said multiple targets comprise all targets.

14. The method of claim 12, and further comprising:
transferring to said multiple targets, half of said multiple blocks of data, if said multiple targets satisfy said request for half of said multiple blocks of data.

15. The method of claim 14, wherein said multiple targets comprise all targets.

16. The method of claim 12, and further comprising:
transmitting a write request for half of an amount of an immediately previous write request, if said multiple targets do not satisfy an amount of data to be transferred of said immediately previous write request.

17. The method of claim 16, wherein said multiple targets comprise all targets.

18. The method of claim 12, wherein at least one of said multiple targets comprises a storage disk.

19. The method of claim 12, wherein said targets comprise systems that are compliant with the fibre channel protocol.

20. The method of claim 12, wherein said targets comprise systems that are compatible with the fibre channel protocol.

21. An article comprising: a storage medium having stored thereon instructions, that, when executed, result in performance of a method of mirroring data to multiple targets where the targets request different data lengths, comprising:
transferring data to multiple targets, if an acceptable data transfer of said multiple targets is greater than 0.

22. The article of claim 21, wherein said storage medium has stored thereon instructions that, when executed, further result in:
transferring data to multiple targets comprising transferring data to all targets.

23. The article of claim 21, wherein said storage medium has stored thereon instructions that, when executed, further result in:
not acting upon a request to transfer data if the request does not raise the acceptable data transfer by said multiple targets.

24. The article of claim 23, wherein said storage medium has stored thereon instructions that, when executed, further result in:
not acting upon a request to transfer data comprising not acting upon a request if the request does not raise the acceptable data transfer by all targets.

25. The article of claim 23, wherein said storage medium has stored thereon instructions that, when executed, further result in:
transferring data to multiple targets if a request for data transfer raises the acceptable data transfer by said multiple targets.

26. The article of claim 25, wherein said storage medium has stored thereon instructions that, when executed, further result in:
transferring data to multiple targets comprising transferring data to all targets.

27. The article of claim 21, wherein said storage medium has stored thereon instructions that, when executed, further result in:
transferring data to multiple targets if a request for data transfer raises the acceptable data transfer by said multiple targets.

28. The article of claim 27, wherein said storage medium has stored thereon instructions that, when executed, further result in:
transferring data to multiple targets comprising transferring data to all targets.

29. An article comprising: a storage medium having stored thereon instructions, that, when executed, result in performance of a method of mirroring multiple blocks of data to multiple targets, if said multiple targets do not satisfy an amount of data to be transferred of said multiple blocks of data, comprising:
transmitting a write request for half of said multiple blocks of data to said multiple targets.

30. The article of claim 29, wherein said storage medium has stored thereon instructions that, when executed, further result in:
said multiple targets comprising all targets.

31. The article of claim 29, wherein said storage medium has stored thereon instructions that, when executed, further result in:
transferring to said multiple targets, half of said multiple blocks of data, if said multiple targets satisfy said request for half of said multiple blocks of data.

32. The article of claim 31, wherein said storage medium has stored thereon instructions that, when executed, further result in:
said multiple targets comprising all targets.

33. The article of claim 29, wherein said storage medium has stored thereon instructions that, when executed, further result in:
transmitting a write request for half of an amount of an immediately previous write request, if said multiple targets do not satisfy an amount of data to be transferred of said immediately previous write request.

34. The article of claim 33, wherein said storage medium has stored thereon instructions that, when executed, further result in:
said multiple targets comprising all targets.

35. A method of mirroring multiple blocks of data to multiple targets, if said multiple targets do not satisfy an amount of data to be transferred of said multiple blocks of data, comprising:
transmitting a write request for a subset of said multiple blocks of data to said multiple targets.

36. The method of claim 35, wherein said multiple targets comprise all targets.

37. The method of claim 35, and further comprising:
transferring to said multiple targets, said subset of said multiple blocks of data, if said multiple targets satisfy said request for said subset of said multiple blocks of data.

38. The method of claim 37, wherein said multiple targets comprise all targets.

39. The method of claim 35, and further comprising:
transmitting a write request for a further subset of an amount of an immediately previous write request, if said multiple targets do not satisfy an amount of data to be transferred of said immediately previous write request.

40. The method of claim 39, wherein said multiple targets comprise all targets.

41. The method of claim 35, wherein at least one of said multiple targets comprises a storage disk.

42. The method of claim 35, wherein said targets comprise systems that are compliant with the fibre channel protocol.

43. The method of claim 35, wherein said targets comprise systems that are compatible with the fibre channel protocol.

44. An article comprising: a storage medium having stored thereon instructions, that, when executed, result in performance of a method of mirroring multiple blocks of data to multiple targets, if said multiple targets do not satisfy an amount of data to be transferred of said multiple blocks of data, comprising:
transmitting a write request for a subset of said multiple blocks of data to said multiple targets.

45. The article of claim 44, wherein said storage medium has stored thereon instructions that, when executed, further result in:
said multiple targets comprising all targets.

46. The article of claim 44, wherein said storage medium has stored thereon instructions that, when executed, further result in:
transferring to said multiple targets, said subset of said multiple blocks of data, if said multiple targets satisfy said request for said subset of said multiple blocks of data.

47. The article of claim 46, wherein said storage medium has stored thereon instructions that, when executed, further result in:
said multiple targets comprising all targets.

48. The article of claim 44, wherein said storage medium has stored thereon instructions that, when executed, further result in:
transmitting a write request for a subset of an amount of an immediately previous write request, if said multiple targets do not satisfy an amount of data to be transferred of said immediately previous write request.

49. The article of claim 48, wherein said storage medium has stored thereon instructions that, when executed, further result in:
said multiple targets comprising all targets.

50. A switch for use in a switched fabric, said switch comprising:
at least a port for coupling to said switched fabric;
a mirroring device capable of mirroring data to multiple targets where the targets request different data lengths;
logic for signal information to pass at least between said port and said mirroring device;
said mirroring device adapted to transfer data to said multiple targets, if an acceptable data transfer of said multiple targets is greater than 0.

51. The switch of claim 50, wherein said mirroring device is further adapted to transfer data to all targets.

52. The switch of claim 50, wherein said mirroring device is further adapted to not act upon a request to transfer data if the request does not raise the acceptable data transfer by said multiple targets.

53. The switch of claim 52, wherein said mirroring device is further adapted to transfer data to multiple targets if a request for data transfer raises the acceptable data transfer by said multiple targets.

54. The switch of claim 50, wherein said mirroring device is further adapted to transfer data to multiple targets if a request for data transfer raises the acceptable data transfer by said multiple targets.

55. The switch of claim 50, wherein at least one of said multiple targets comprises a storage disk.

56. The switch of claim 50, wherein said targets comprise systems that are compliant with the fibre channel protocol.

57. The switch of claim 50, wherein said targets comprise systems that are compatible with the fibre channel protocol.

58. The switch of claim 50, wherein said switch comprises a first switch;
and further comprising:
a second switched coupled to said first switch to form a switched fabric.

59. A switch for use in a switched fabric, said switch comprising:
at least a port for coupling to said switched fabric;
a mirroring device capable of mirroring multiple blocks of data to multiple targets, if said multiple targets do not satisfy an amount of data to be transferred of multiple blocks of data:
logic for signal information to pass at least between said port and said mirroring device;
said mirroring device being adapted to transmit a write request for a subset of said multiple blocks of data to said multiple targets.

60. The switch of claim 59, wherein said multiple targets comprise all targets.

61. The switch of claim 59, wherein said mirroring device is further adapted to transfer to said multiple targets, said subset of said multiple blocks of data, if said multiple targets satisfy said request for said subset of said multiple blocks of data.

62. The switch of claim 61, wherein said multiple targets comprise all targets.

63. The switch of claim 59, wherein said mirroring device is further adapted to transmit a write request for a further subset of an amount of an immediately previous write request, if said multiple targets do not satisfy an amount of data to be transferred of said immediately previous write request.

64. The switch of claim 59, wherein said multiple targets comprise all targets.

65. The switch of claim 59, wherein at least one of said multiple targets comprises a storage disk.

66. The switch of claim 59, wherein said targets comprise systems that are compliant with the fibre channel protocol.

67. The switch of claim 59, wherein said targets comprise systems that are compatible with the fibre channel protocol.

68. A switched fabric comprising:
a first switch; and
a second switch coupled to said first switch, said second switch including:
at least a port;
a mirroring device capable of mirroring data to multiple targets where the targets request different data lengths;
logic for signal information to pass at least between said port and said mirroring device;
said mirroring device adapted to transfer data to multiple targets, if the minimum acceptable data transfer of said multiple targets is greater than 0.

69. The switched fabric of claim 68, wherein said mirroring device is further adapted to transfer data to all targets.

70. The switched fabric of claim 68, wherein said mirroring device is further adapted to not act upon a request to transfer data if the request does not raise the acceptable data transfer by said multiple targets.

71. The switched fabric of claim 70, wherein said mirroring device is further adapted to transfer data to multiple targets if a request for data transfer raises the acceptable data transfer by said multiple targets.

72. The switched fabric of claim 68, wherein said mirroring device is further adapted to transfer data to multiple targets if a request for data transfer raises the acceptable data transfer by said multiple targets.

73. The switched fabric of claim 68, wherein at least one of said multiple targets comprises a storage disk.

74. The switched fabric of claim 68, wherein said targets comprise systems that are compliant with the fibre channel protocol.

75. The switched fabric of claim 68, wherein said targets comprise systems that are compatible with the fibre channel protocol.

76. A switched fabric comprising:
a first switch; and
a second switch coupled to said first switch, said second switch including:
at least a port;
a mirroring device capable of mirroring multiple blocks of data to multiple targets, if said multiple targets do not satisfy an amount of data to be transferred of multiple blocks of data;
logic for signal information to pass at least between said port and said mirroring device;
said mirroring device being adapted to transmit a write request for a subset of said multiple blocks of data to said multiple targets.

77. The switched fabric of claim 76, wherein said multiple targets comprise all targets.

78. The switched fabric of claim 76, wherein said mirroring device is further adapted to transfer to said multiple targets, said subset of said multiple blocks of data, if said multiple targets satisfy said request for said subset of said multiple blocks of data.

79. The switched fabric of claim 78, wherein said multiple targets comprise all targets.

80. The switched fabric of claim 76, wherein said mirroring device is further adapted to transmit a write request for a further subset of an amount of an immediately previous write request, if said multiple targets do not satisfy an amount of data to be transferred of said immediately previous write request.

81. The switched fabric of claim 76, wherein said multiple targets comprises all targets.

82. The switched fabric of claim 76, wherein at least one of said multiple targets comprises a storage disk.

83. The switched fabric of claim 76, wherein said targets comprise systems that are compliant with the fibre channel protocol.

84. A network comprising:
a host;
a physical storage unit;
a first switch; and
a second switch coupled to said first switch and forming a switched fabric, said first switch and said second switch coupled to said host and said physical storage unit, said first switch including:
at least a port;
a mirroring device capable of mirroring data to multiple targets where the targets request different data lengths;
logic for signal information to pass at least between said port and said mirroring device;
said mirroring device adapted to transfer data to multiple targets, if the minimum acceptable data transfer of said multiple targets is greater than 0.

85. The network of claim 84, wherein said mirroring device is further adapted to transfer data to all targets.

86. The network of claim 84, wherein said mirroring device is further adapted to not act upon a request to transfer data if the request does not raise the acceptable data transfer by said multiple targets.

87. The network of claim 86, wherein said mirroring device is further adapted to transfer data to multiple targets if a request for data transfer raises the acceptable data transfer by said multiple targets.

88. The network of claim 84, wherein said mirroring device is further adapted to transfer data to multiple targets if a request for data transfer raises the acceptable data transfer by said multiple targets.

89. The network of claim 84, wherein at least one of said multiple targets comprises a storage disk.

90. The network of claim 84, wherein said targets comprise systems that are compliant with the fibre channel protocol.

91. The network of claim 84, wherein said targets comprise systems that are compatible with the fibre channel protocol.

92. A network comprising:
a host;
a physical storage unit;
a first switch; and
a second switch coupled to said first switch and forming a switched fabric, said first switch and said second switch coupled to said host and said physical storage unit, said first switch including:
at least a port;
a mirroring device capable of mirroring multiple blocks of data to multiple targets, if said multiple targets do not satisfy an amount of data to be transferred of multiple blocks of data;
logic for signal information to pass at least between said port and said mirroring device;
said mirroring device being adapted to transmit a write request for a subset of said multiple blocks of data to said multiple targets.

93. The network of claim 92, wherein said multiple targets comprise all targets.

94. The network of claim 92, wherein said mirroring device is further adapted to transfer to said multiple targets, said subset of said multiple blocks of data, if said multiple targets satisfy said request for said subset of said multiple blocks of data.

95. The network of claim 94, wherein said multiple targets comprise all targets.

96. The network of claim 92, wherein said mirroring device is further adapted to transmit a write request for a further subset of an amount of an immediately previous write request, if said multiple targets do not satisfy an amount of data to be transferred of said immediately previous write request.

97. The network of claim 92, wherein said multiple targets comprise all targets.

98. The network of claim 92, wherein at least one of said multiple targets comprises a storage disk.

99. The network of claim 92, wherein said targets comprise systems that are compliant with the fibre channel protocol.

100. The apparatus of claim 92, wherein said targets comprise systems that are compatible with the fibre channel protocol.
